(19) United States
(12) Patent Application Publication
(10) Pub. No.: US 2026/0357957 A1
(43) Pub. Date: Nov. 12, 2026

(54) LIGHTING DEVICE

(71) Applicant: HANGZHOU GREAT STAR INDUSTRIAL CO., LTD., Hangzhou (CN)

(72) Inventor: Wentian YU, Hangzhou (CN)

(21) Appl. No.: 19/686,812

(22) Filed: May 25, 2026

Related U.S. Application Data
(63) Continuation of application No. PCT/CN2026/092719, filed on Apr. 24, 2026.

(30) Foreign Application Priority Data
May 8, 2025 (CN) 202520896979.9

(51) Int. Cl. F21L 4/08

(52) U.S. Cl. CPC F21L 4/08

(57) ABSTRACT

A lighting device is provided. The lighting device includes a lighting lamp and a charging base. The charging base comprises a base body and a charging portion provided on the base body. The lighting lamp is detachably disposed on the base body. When the lighting lamp is disposed on the base body, the lighting lamp is in electrical connection with the charging portion.

### CROSS-REFERENCE TO RELATED APPLICATION

This application is a continuation of international patent application No. PCT/CN2026/092719, filed on Apr. 24, 2026, which itself claims priority to Chinese patent application No. 202520896979.9, filed on May 8, 2025, and titled “LIGHTING DEVICE”, the content of which is hereby incorporated by reference in its entirety.

### TECHNICAL FIELD

The present disclosure relates to the field of lighting lamp technology, in particular, to a lighting device.

### BACKGROUND

In the related art, lighting devices, such as flashlights and headlamps, are widely used due to portable lighting functions thereof.

However, methods for supplying energy to the lighting lamps in the related art have significant limitations. The lighting lamps usually require an external connection to a fixed power supply via a charging cable to transfer electrical energy. As a result, during the charging process, the lighting lamps cannot be carried and used. Moreover, in outdoor situations, there may be instances where the lighting devices cannot be charged in time and would be out of work, thus restricting application scenarios of the lighting devices.

### SUMMARY

On the basis of embodiments of the present disclosure, a portable lighting device having a portable charging function is provided.

The present disclosure provides a lighting device. The lighting device includes a lighting lamp and a charging base. The charging base includes a base body and a charging portion provided on the base body. The lighting lamp is detachably disposed on the base body. When the lighting lamp is disposed on the base body, the lighting lamp is in electrical connection with the charging portion.

In some embodiments, the base body includes a charging part, the charging part includes an opening for the lighting lamp to enter, and the charging portion is disposed in the charging part.

In some embodiments, the base body includes a first side portion and a second side portion opposite to each other, and the first side portion and the second side portion are spaced from each other. Both the first side portion and the second side portion extend along a length of the lighting lamp. The charging part is a concave groove located on the first side portion. The opening faces a direction away from the second side portion and is configured to allow a side portion of the lighting lamp to enter.

In some embodiments, the lighting device further includes a connecting structure. The connecting structure includes a first connecting member and a second connecting member detachably connected with each other, the first connecting member is fixed to a sidewall of the charging part, and the second connecting member is fixed to an outer sidewall of the lighting lamp. When the first connecting member is in connection with the second connecting member, the lighting lamp is in electrical connection with the charging portion.

In some embodiments, the first connecting member is in magnetic connection with the second connecting member. One of the first connecting member and the second connecting member is configured as a first magnetic member, and another of the first connecting member and the second connecting member is configured as a magnetic conductive member or a second magnetic member. In some embodiments, the first connecting member is connected to the second connecting member in a snapping manner.

In some embodiments, the lighting device includes at least two connecting structures, the at least two connecting structures are spaced from each other along a length of the first side portion, and the charging portion is located between the at least two connecting structures.

In some embodiments, the lighting lamp includes a housing and a lamp body. The lamp body is provided at a position adjacent to a first end of the housing in the housing. The charging part extends along a length of the lighting lamp, and the charging part is provided with a first recessed portion configured to give way to the first end of the housing. In some embodiments, a second recessed portion is disposed at a position corresponding to the lamp body on a sidewall of the charging part, and the second recessed portion is configured for allowing the light to pass through.

In some embodiments, a sidewall of the charging part includes two first sidewalls opposite to each other and a second sidewall configured for connecting the two first sidewalls, the second sidewall is opposite to the opening, and the charging portion is located on the second sidewall.

In some embodiments, the base body and/or the lighting lamp is provided with an electrical connection member configured to supply electric energy, and the electrical connection member is in electrical connection with an external power supply.

In some embodiments, the charging portion is an electrical contact, a magnetic connector or a USB interface.

Details of one or more embodiments of the present application are presented in the following accompanying drawings and description in order to make other features, purposes and advantages of the present application more concise and understandable.

### BRIEF DESCRIPTION OF THE DRAWINGS

In order to better describe and illustrate the embodiments and/or examples of the present application disclosed herein, reference may be made to one or more of the accompanying drawings. The additional details or examples used to describe the accompanying drawings should not be considered a limitation on the scope of any of the disclosed applications, the embodiments and/or examples currently described, and the best mode of these applications as currently understood.

FIG. 1 is a perspective view of a lighting device in an embodiment of the present disclosure.

FIG. 2 is a sectional view of the lighting device in FIG. 1.

FIG. 3 is a perspective decomposition diagram of the lighting device in FIG. 1.

FIG. 4 is a schematic diagram of a charging base in FIG. 1.

FIG. 5 is a schematic diagram of a charging base according to an embodiment of the present disclosure.

FIG. 6 is a schematic diagram of a charging base according to an embodiment of the present disclosure.

FIG. 7 is a perspective decomposition diagram of a lighting device in an embodiment of the present disclosure.

In the figures, 1 represents a lighting lamp; 11 represents a housing; 110 represents a cavity; 111 represents a housing body; 112 represents a lampshade; 12 represents a lamp body; 13 represents a second battery; 14 represents an electrical connection portion; 2 represents a charging base; 21 represents a base body; 211 represents a charging part; 2110 represents an opening; 2111 represents a first sidewall; 2112 represents a second sidewall; 2113 represents a first recessed portion; 2114 represents a second recessed portion; 212 represents a first side portion; 213 represents a second side portion; 22 represents a charging portion; 221 represents an electrical contact; 222 represents a magnetic connector; 223 represents a USB interface; 23 represents a first battery; 4 represents a connecting structure; 41 represents a first connecting member; and 42 represents a second connecting member.

### DETAILED DESCRIPTION

In order that the foregoing purposes, features and advantages of the present disclosure may be made more apparent and understandable, specific embodiments of the present disclosure are described in detail below in conjunction with the accompanying drawings. Many specific details are set forth in the following description to facilitate a full understanding of the present disclosure. However, the present disclosure is capable of being implemented in many other ways different from those described herein, and those skilled in the art may make similar improvements without violating the connotations of the present disclosure, and thus the present disclosure is not limited by the specific embodiments disclosed below.

It is noted that when a component is said to be “fixed to” or “disposed on” another component, it may be directly on the other component or there may be a centred component. When a component is said to be “connected” to another component, it may be directly connected to the other component or there may be both centred components. The terms “vertical”, “horizontal”, “up”, “down”, “left”, “right” and similar expressions used in the specification of the present disclosure are for illustrative purposes only and are not meant to be exclusive. The terms “vertical”, “horizontal”, “upper”, “lower”, “left”, “right”, “side”, “top”, “bottom” and similar expressions used in the specification of the present disclosure are merely for the purpose of describing various exemplary structural parts and components of the present disclosure. The use of these terms is only for the convenience of explanation and is determined based on the exemplary orientation shown in the drawings, and does not represent the only implementation mode. Since the disclosed embodiments of the present disclosure can be set in different directions, these terms indicating directions are only for explanation and should not be regarded as limitations. For example, “upper” and “lower” are not necessarily limited to the directions opposite or consistent with the direction of gravity.

Furthermore, the terms “first”, “second” are used for descriptive purposes only and are not to be understood as indicating or implying relative importance or implicitly specifying the number of technical features indicated. Thus, a feature defined with the terms “first”, “second” may include at least one such feature, either explicitly or implicitly. In the description of the present disclosure, “plurality” means at least two, e.g., two, three, etc., unless otherwise expressly and specifically limited.

In the present disclosure, unless otherwise expressly specified and limited, the first feature “on” or “under” the second feature may be that the first feature is in direct contact with the second feature, or that the first feature is in indirect contact with the second feature through an intermediate medium. Furthermore, the first feature being “above”, “on” or “upon” the second feature may mean that the first feature is directly above or diagonally above the second feature, or it may simply mean that the first feature is horizontally higher than the second feature. The first feature being “below”, “under” or “beneath” the second feature may be that the first feature is directly below or diagonally below the second feature, or it may simply mean that the first feature is horizontally smaller than the second feature.

It should be noted that “axial arrangement” refers to the overall arrangement direction along the axial direction, including but not limited to axial extension, and can form an angle with the axial direction.

Unless otherwise defined, all technical and scientific terms used in the specification of the present disclosure have the same meaning as commonly understood by those skilled in the art to which the present disclosure belongs. Terms used in the specification of the present disclosure are used only for the purpose of describing specific embodiments and are not intended to limit the present disclosure. The term “and/or” as used in the specification of the present disclosure includes any and all combinations of one or more of the relevant listed items.

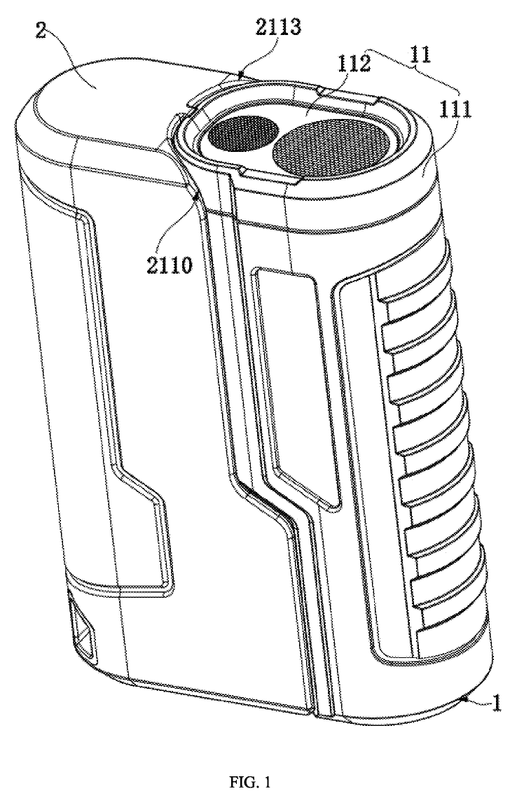

Referring to FIGS. 1-7, the present disclosure provides a lighting device. The lighting device includes a lighting lamp 1 and a charging base 2. The charging base 2 includes a base body 21 and a charging portion 22 provided on the base body 21. The lighting lamp 1 is detachably disposed on the base body 21. When the lighting lamp 1 is disposed on the base body 21, the lighting lamp 1 is in electrical connection with the charging portion 22.

It could be understood that the lighting lamp 1 can be charged by connecting to the charging portion 22 of the charging base 2. That is, the lighting lamp 1 can be charged by providing the charging base 2, and charging of the lighting lamp 1 could be not entirely relied on an external power supply. Since the lighting lamp 1 is detachably connected to the charging base 2, on the one hand, the lighting lamp 1 can be carried independently for lighting; on the other hand, the charging base 2 and the lighting lamp 1 can be carried together, thus the lighting lamp 1 can be charged while moving, and application scenarios can be increased, thereby facilitating meeting requirements of the user.

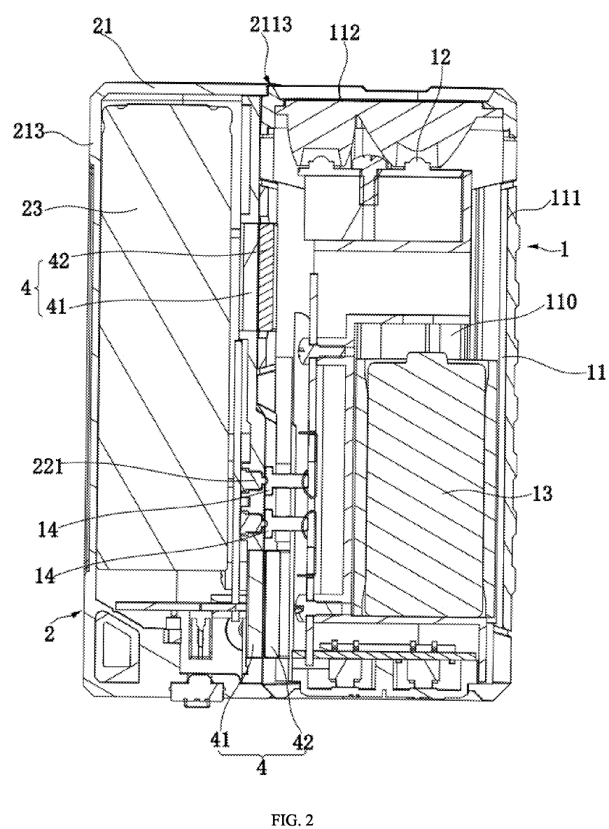

In some embodiments, referring to FIG. 2, the base body 21 can include a charging part 211, the charging part 211 can include an opening 2110 for the lighting lamp 1 to enter, and the charging portion 22 can be disposed in the charging part 211. Since the base body 21 includes the charging part 211, the lighting lamp 1 can be accommodated conveniently and protected.

The charging part 211 can be formed on a top of the base body 21. In some embodiments, the top of the base body 21 can be recessed down to define the charging part 211 (not shown in the figures).

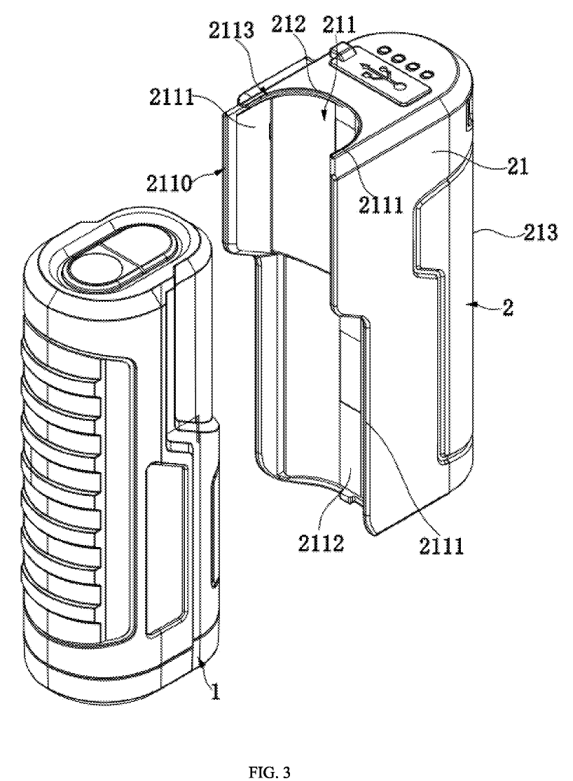

The charging part 211 can be formed on a side portion of the base body 21. In some embodiments, referring to FIGS. 2 and 3 , the base body 21 can include a first side portion 212 and a second side portion 213 opposite to each other, and the first side portion 212 and the second side portion 213 can be spaced from each other. Both the first side portion 212 and the second side portion 213 can extend along a length of the lighting lamp 1. The charging part 211 can be a concave groove located on the first side portion 212. The opening 2110 can face a direction away from the second side portion 213 and can be configured to allow a side portion of the lighting lamp 1 to enter, thereby facilitating taking out and putting in the lighting lamp 1.

Methods for forming the concave groove can be various. In some embodiments, the concave groove can be directly formed on the first side portion 212. In some embodiments, referring to FIG. 2, the first side portion 212 can be recessed towards the second side portion 213 to form the concave groove.

In some embodiments, referring to FIGS. 2 and 3 , a sidewall of the charging part 211 can include two first sidewalls 2111 opposite to each other and a second sidewall 2112 configured for connecting the two first sidewalls 2111, the second sidewall 2112 can be opposite to the opening 2110, and the charging portion 22 can be located on the second sidewall 2112. The number of the charging portions 22 can be two. The two charging portions 22 can be arranged spaced from each other along the length of the lighting lamp 1.

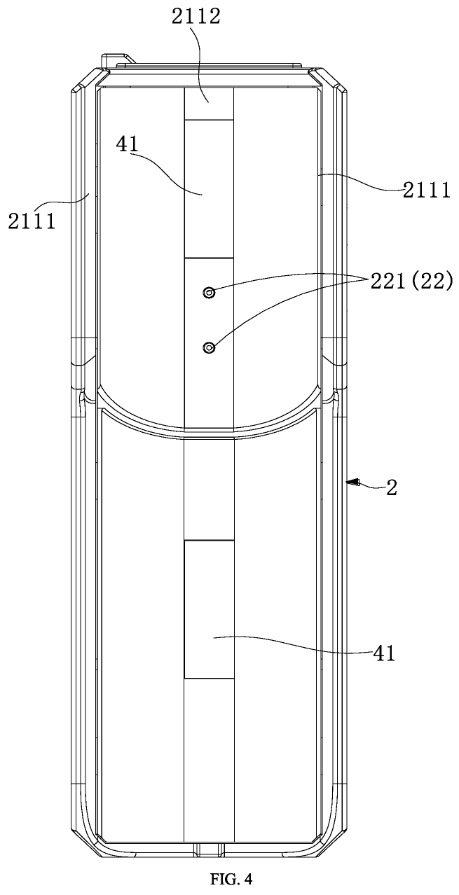

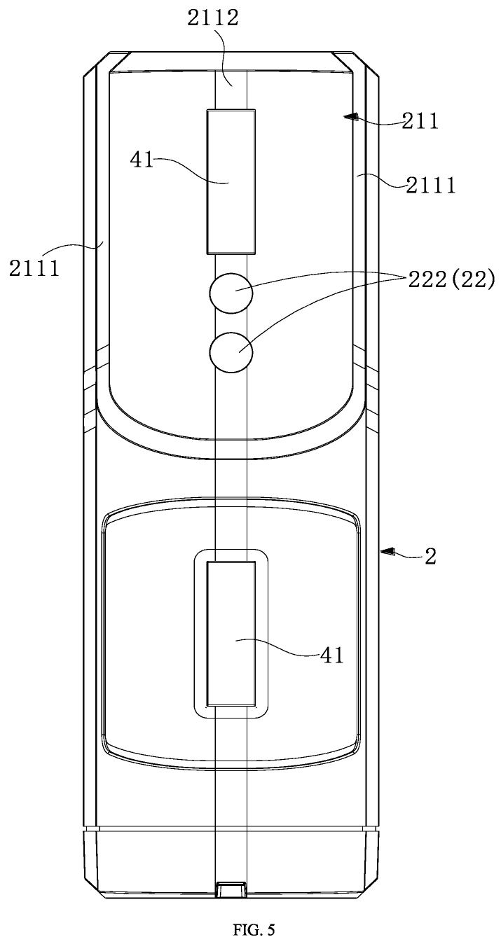

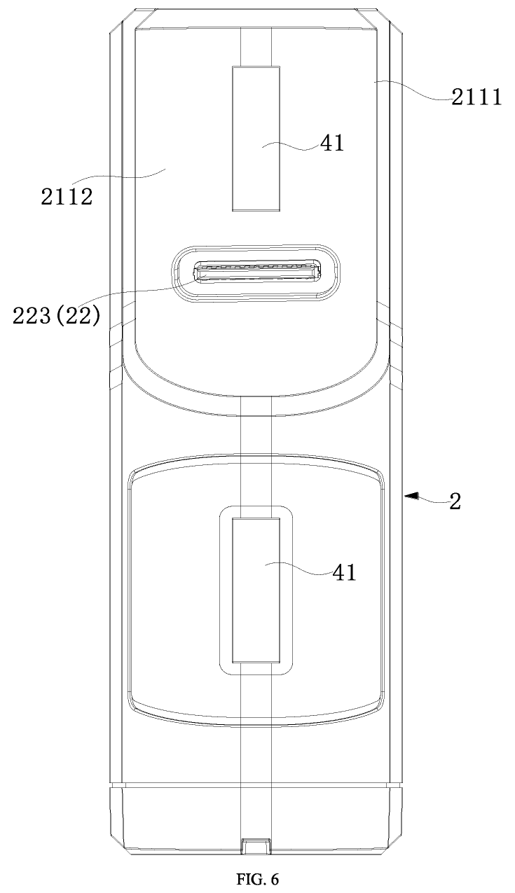

Referring to FIGS. 2 and 4 , it could be noted that the charging portion 22 can be an electrical contact 221. Referring to FIG. 5, it could be noted that the charging portion 22 can be a magnetic connector 222. At this time, the electrical connection portion 14 of the lighting lamp 1 can be in magnetic engagement with the magnetic connector 222. Referring to FIG. 6, it could be noted that the charging portion 22 can be a USB interface 223. At this time, the electrical connection portion 14 of the lighting lamp 1 can be a plug fitting with the USB interface 233.

In some embodiments, referring to FIGS. 1-3, when at least a part of the lighting lamp 1 is located in the charging part 211, a sidewall of the charging part 211 can fit with a corresponding outer sidewall of the lighting lamp 1. In this way, the lighting lamp 1 can fit with the charging part 211 better.

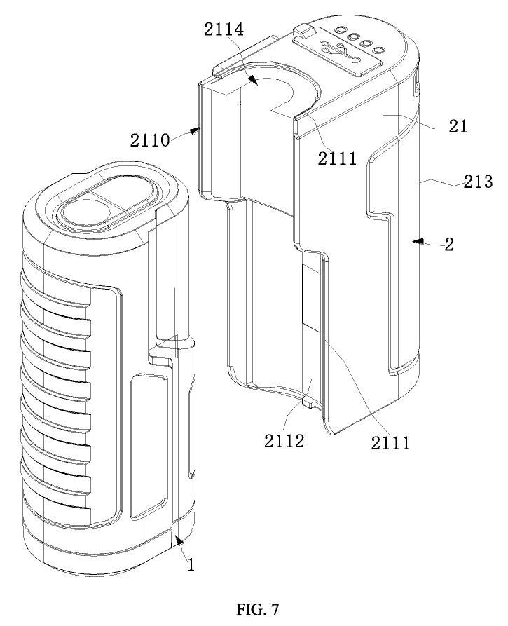

In some embodiments, referring to FIG. 2, the charging part 211 can extend along a length of the lighting lamp 1, and the lighting lamp 1 can include a housing 11 and a lamp body 12. The lamp body 12 can be provided at a position adjacent to a first end of the housing 11 in the housing 11. In some embodiments, the charging part 211 can be provided with a first recessed portion 2113 configured to give way to the first end of the housing 11. In some embodiments, referring to FIG. 7, a second recessed portion 2114 can be disposed at a position corresponding to the lamp body 12 on a sidewall of the charging part 211, and the second recessed portion 2114 can be configured for allowing the light to pass through. In this way, the lighting lamp 1 can be used for lighting while charging.

In some embodiments, each of the two ends of the charging receptable 211 can be provided with a receptacle opening, and the receptacle opening can be in communication with the opening 2110. One of the two receptacle openings can be the first recessed portion 2113.

In some embodiments, referring to FIGS. 1-3, the housing 11 can include a housing body 111 and a lampshade 112. A first end of the housing body 111 can be provided with a notch portion, the lampshade 112 can cover the notch portion and enclose with the housing body 111 to form the cavity 110, and the lamp body 12 can be located in the cavity 110. A sidewall of the housing body 111 can be provided with an electrical connection portion 14 that can be in electrical connection with the charging portion 22. The number of the charging portion 22 can be two, and the two charging portions 22 can be a positive electrode and a negative electrode, respectively. Each of the two charging portions 22 can be corresponding to one of the two charging portions 22.

In some embodiments, the base body 21 and/or the lighting lamp 1 can be provided with an electrical connection member configured to supply electric energy, and the electrical connection member is in electrical connection with an external power supply. That is, at least one of the base body 21 and the lighting lamp 1 can be provided with an electrical connection member, and the electrical connection member can be configured to allow the electricity to be supplied.

It could be understood that when the base body 21 is provided with the electrical connection member, the electrical connection member can be in electrical connection with the charging portion 22. Thus, the charging base 2 can be charged by an external power supply. When the lighting lamp 1 is disposed on the base body 21, the external power supply can be configured to charge the lighting lamp 1. When the lighting lamp 1 is provided with an electrical connection member, the electrical connection member of the lighting lamp 1 can be in electrical connection with the electrical connection portion 14. Thus, the lighting lamp 1 can be charged with the external power supply. When the lighting lamp 1 is disposed on the base body 21, the external power supply can be configured to charge the charging base 2.

In some embodiments, both the lighting lamp 1 and the charging base 2 can be provided with the electrical connection member.

In some embodiments, the charging base 2 can further include a first battery 23, the first battery 23 can be disposed in the base body 21, and the first battery 23 can be in electrical connection with the charging portion 22. The first battery 23 can be a rechargeable battery, such as a storage battery. In some embodiments, a non-rechargeable battery, such as a dry battery, can be disposed in the charging base 2.

In some embodiments, the lighting lamp 1 can further include a second battery 13, the second battery 13 can be disposed in the housing 11, and the second battery 13 can be in electrical connection with the electrical connection portion 14. In some embodiments, the second battery can be accommodated in the cavity 110, and both the electrical connection portion 14 and the lamp body 12 can be in electrical connection with the second battery 13. In some embodiments, the second battery 13 can be a rechargeable battery, such as a storage battery. In some embodiments, the second battery 13 can include a rechargeable battery and a non-rechargeable battery. The non-rechargeable battery can be a dry battery. In this way, when the rechargeable battery is under voltage, the lamp body can be powered by the non-rechargeable battery.

In some embodiments, the lighting device can further include a connecting structure 4. In some embodiments, the connecting structure 4 can include a first connecting member 41 and a second connecting member 42 detachably connected with each other, and the first connecting member 41 can be fixed to a sidewall of the charging base 2. In some embodiments, the first connecting member 41 can be fixed to a sidewall of the charging part 211, and the second connecting member 42 can be fixed to an outer sidewall of the lighting lamp 1. When the first connecting member 41 is in connection with the second connecting member 42, the electrical connection portion 14 of the lighting lamp 1 can be in electrical connection with the charging portion 22. After the charging accomplished, since the first connecting member 41 is detachably connected to the second connecting member 42, the lighting lamp 1 can separate from the charging base 2.

In this way, when the lighting lamp 1 is in electrical connection with the charging portion 22, the lighting lamp 1 can be more reliably fixed to the charging base 2 via the connecting structure 4, thereby avoiding poor contact between the lighting lamp 1 and the charging portion 22 due to movement of the lighting lamp 1 relative to the charging base 2.

It should be noted that when electric quantity of the lighting device is lower than a certain threshold value, the external power supply can charge the charging base and the lighting lamp at the same time. When the electric quantity of the lighting device is higher than a certain threshold value, the external power supply merely charges the charging base.

In some embodiments, the first connecting member 41 can be in magnetic engagement fit with the second connecting member 42. One of the first connecting member 41 and the second connecting member 42 can be configured as a first magnetic member, and another of the first connecting member 41 and the second connecting member 42 can be configured as a magnetic conductive member or a second magnetic member. The magnetic conductive member can be a metal member. In some embodiments, the first connecting member 41 can be connected to the second connecting member 42 in a snapping manner. In some embodiments, one of the first connecting member 41 and the second connecting member 42 can be configured as a first snap latch, and another of the first connecting member 41 and the second connecting member 42 can be configured as a snap recess that can fit with the first snap latch in a snapping manner, optionally, the other of the first connecting member 41 and the second connecting member 42 can be configured as a second snap latch.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A lighting device, comprising a lighting lamp and a charging base, wherein the charging base comprises a base body and a charging portion provided on the base body, the lighting lamp is detachably disposed on the base body, and when the lighting lamp is disposed on the base body, the lighting lamp is in electrical connection with the charging portion.

2. The lighting device of claim 1, wherein the base body comprises a charging part, the charging part comprises an opening for the lighting lamp to enter, and the charging portion is disposed in the charging part.

3. The lighting device of claim 2, wherein the base body comprises a first side portion and a second side portion opposite to each other, the first side portion and the second side portion are spaced from each other, both the first side portion and the second side portion extend along a length of the lighting lamp, the charging part is a concave groove located on the first side portion, and the opening faces a direction away from the second side portion and is configured to allow a side portion of the lighting lamp to enter.

4. The lighting device of claim 3, further comprising a connecting structure, wherein the connecting structure comprises a first connecting member and a second connecting member detachably connected with each other, the first connecting member is fixed to a sidewall of the charging part, the second connecting member is fixed to an outer sidewall of the lighting lamp, when the first connecting member is in connection with the second connecting member, the lighting lamp is in electrical connection with the charging portion.

5. The lighting device of claim 4, wherein the first connecting member is in magnetic connection with the second connecting member, one of the first connecting member and the second connecting member is configured as a first magnetic member, and another of the first connecting member and the second connecting member is configured as a magnetic conductive member or a second magnetic member.

6. The lighting device of claim 4, wherein the first connecting member is connected to the second connecting member in a snapping manner

7. The lighting device of claim 4, wherein the lighting device comprises at least two connecting structures, the at least two connecting structures are spaced from each other along a length of the first side portion, and the charging portion is located between the at least two connecting structures.

8. The lighting device of claim 2, wherein the lighting lamp comprises a housing and a lamp body, the lamp body is provided at a position adjacent to a first end of the housing in the housing, the charging part extends along a length of the lighting lamp, the charging part is provided with a first recessed portion configured to give way to the first end of the housing.

9. The lighting device of claim 2, wherein a second recessed portion is disposed at a position corresponding to the lamp body on a sidewall of the charging part, and the second recessed portion is configured for allowing the light to pass through.

10. The lighting device of claim 3, wherein a sidewall of the charging part comprises two first sidewalls opposite to each other and a second sidewall configured for connecting the two first sidewalls, the second sidewall is opposite to the opening, and the charging portion is located on the second sidewall.

11. The lighting device of claim 2, wherein the base body and/or the lighting lamp is provided with an electrical connection member configured to supply electric energy, and the electrical connection member is in electrical connection with an external power supply.

12. The lighting device of claim 1, wherein the charging portion is an electrical contact, a magnetic connector or a USB interface.
